(19) United States
(12) Patent Application Publication
(10) Pub. No.: US 2001/0039390 A1
(43) Pub. Date: Nov. 8, 2001

(54) Back massage device

(76) Inventor: Jeffery J. Barrett, Newark, OH (US)

Correspondence Address: STANDLEY & GILCREST LLP, 495 METRO PLACE SOUTH, SUITE 210, DUBLIN, OH, 43017, US

(21) Appl. No.: 09/835,951

(22) Filed: Apr. 16, 2001

Related U.S. Application Data
(60) Provisional application No. 60/197,435, filed on Apr. 14, 2000.

(51) Int. Cl. A61H 7/00

(52) U.S. Cl. 601/90; 601/89

(57) ABSTRACT

A massage device for massaging a person's back and other body parts with or without the assistance of another person. The massage device is comprised of rollers that are rotatably attached to a frame. The rollers are adapted to rotate simultaneously and synchronously in a predetermined pattern of clockwise and counterclockwise movements.

This Application claims the benefit of U.S. Provisional Application No. 60/197,435, filed Apr. 14, 2000, which is hereby incorporated by reference in its entirety.

### BACKGROUND AND SUMMARY OF THE INVENTION

The present invention relates generally to a device for massaging a person's body and, more particularly, to a device for massaging a person's back. It should, however, be recognized that the device can be used to massage other portions of a person's body in addition to and/or instead of the person's back. For example, the device can be used to massage a person's lower body, middle body, front side, lateral sides, or any other desired portion of the body.

Many people enjoy having their back and other body portions massaged. In addition, massages can be part of a therapy regimen. Accordingly, it is desired to have a device that can perform massages with or without the assistance of another person. The present invention satisfies this need.

In addition to the novel features and advantages mentioned above, other objects and advantages of the present invention will be readily apparent from the following descriptions of the drawings and preferred embodiments.

### BRIEF DESCRIPTION OF THE DRAWINGS

FIG. 1 is a cross sectional view of one embodiment of the present invention;

FIG. 2 is a top plan view of a second embodiment of the present invention (some features are indicated in phantom in order to more clearly show this embodiment of the invention); and

FIG. 3 is a cross sectional view of a third embodiment of the present invention.

### DETAILED DESCRIPTION OF PREFERRED EMBODIMENT(S)

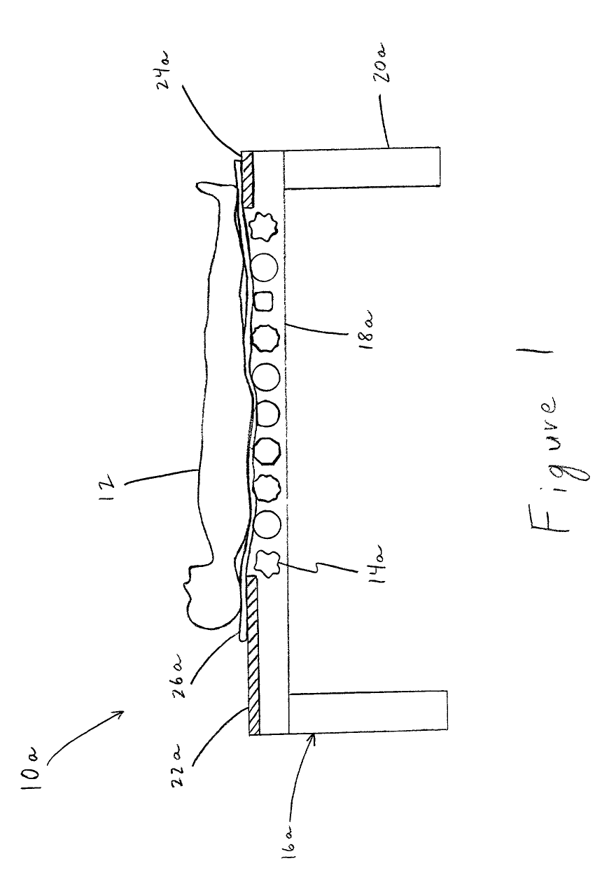

The present invention is directed to a device for performing back and other bodily massages. FIG. 1 is a cross sectional view of an embodiment 10a of the present invention. In FIG. 1, a person 12 is lying on the massage device 10a. The massage device 10a is comprised of at least one roller 14a. In this embodiment, the device 10a is comprised of 10 rollers 14a. The rollers 14a are supported by a frame 16a. In this example, the frame 16a is comprised of at least one support member 18a and at least one leg 20a. Most preferably, the massage device 10a is comprised of two support members 18a and four legs 20a. Optionally, the frame 16a may also include a headrest 22a and a footrest 24a.

A cover 26a may be positioned over the rollers 14a for the person 12 to lie on. The cover 26a may be a rug, a blanket, a sheet, a comforter, a mat, a pad, a cushion, carpet, “egg crate” foam padding, or any other desired piece of material. The cover 26a may be secured to the frame 16a, or it may be loosely placed over the rollers 14a and/or the frame 16a. Additionally, it should be recognized that a separate cover 26a may be individually wrapped around each roller 14a. The type of cover 26a may be selected to serve one or many different purposes. For instance, the cover 26a may be used to prevent body parts or clothing from falling between the rollers 14a, or it may be used to achieve a desired massaging effect.

The rollers 14a are rotatably attached to the frame 16a. The joint between the rollers 14a and the frame 16a may be any type of joint that enables the rollers 14a to rotate relative to the frame 16a. For example, the joint may be a ball-and-socket joint. Another example of the joint is one in which a pin, a peg, a post, a cylinder, a dowel, or any other suitable device is secured to an end of a roller 14a, and such device is inserted into a cylinder or bushing extending from the frame 16a or into a recess in the frame 16a to enable rotation. Alternatively, a pin, a peg, a post, a cylinder, a dowel, or any other suitable device can be secured to the frame 16a, and such device can be inserted into a cylinder or bushing extending from an end of a roller 14a or into a recess in the end of the roller 14a to enable rotation. It should be recognized that the joints may be lubricated.

The rollers 14a may have a single shape or a variety of different shapes. For example, the rollers 14a of the massage device 10a have many different shapes. Some of the rollers 14a are round while others have one or more flat surfaces or other variations in the surface, e.g., gradual and/or abrupt curves. The shape of the rollers 14a may be selected to achieve a desired massaging effect.

The rollers 14a and the frame 16a may be made of any desired material(s). For example, the rollers 14a and the frame 16a may be made from wood, metal, plastic, rubber, or other suitable natural or synthetic materials. Any conventional manufacturing techniques may be used to make the rollers 14a and the frame 16a.

There may be a gap between adjacent rollers 14a as shown in FIG. 1. The gap preferably lessens the likelihood that a body part or a piece of material, e.g., clothing, will be pinched or otherwise caught between rollers 14a. The rollers 14a may rotate in one direction or in both directions, i.e., clockwise and counterclockwise. In addition, each of the rollers 14a preferably rotate in the same direction. However, it should be recognized that the rollers 14a may simultaneously rotate in opposing directions. In one embodiment of the invention, the rollers 14a rotate simultaneously and synchronously back and forth for desired distances, i.e., each of the rollers rotates clockwise then counterclockwise, and the rotation pattern repeats itself. The back and forth motion is preferably such that it enables a person to roll in one direction over the rollers 14a and then in an opposite direction over the rollers 14a without falling off the massage device 10a. In order to achieve the desired rotational motion, the rollers 14a may be powered by an electric or gas motor or any other suitable type of actuating device.

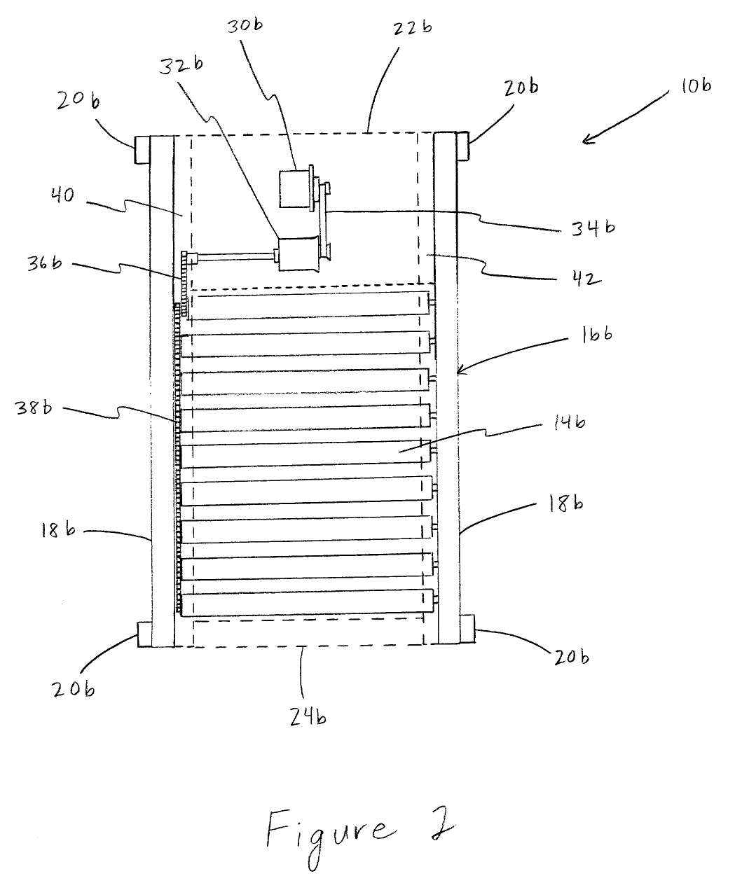

FIG. 2 shows an embodiment 10b of the massage device. The massage device 10b may include any of the optional or preferred features of the above-described embodiment. The optional headrest 22b and footrest 24b are shown in phantom in order to illustrate other features of the massage device 10b. In addition, it should be recognized that the headrest 22b may alternatively be used to support a person's feet, and the footrest 24b may be used to support a person's head.

The massage device 10b is powered by a motor 30b. The motor 30b drives a gear mechanism 32b via a belt or chain 34b. The gear mechanism 32b actuates the rollers 14b via chain 36b and chain 38b. Chains 36b and 38b rotate on sprockets or other suitable devices that are secured to an end of each of the rollers 14b. In this example, the chain 36b preferably actuates one roller 14b which in turn actuates the remaining rollers 14b via chain 38b. It should be recognized that massage device 10b shows just one example of rotating the rollers 14b. In alternative embodiments of the present invention, the rollers can be rotated using any similar, suitable, or conventional mechanisms, e.g., mechanical or electromechanical systems.

The motor 30b and the gear mechanism 32b may be located in any suitable position. It is preferred that the motor 30b and the gear mechanism 32b are remotely located or otherwise covered so as to lessen the likelihood of injury. In this example, the motor 30b and the gear mechanism 32b are located beneath the headrest 22b. In order to prevent body parts, clothing, or other materials from being caught in chains 36b or 38b or in between the rollers 14b and the frame 16b, the massage device 10b preferably includes cover pieces 40 and 42. The cover pieces 40 and 42 are shown in phantom in order to more clearly illustrate the other features of the invention. The cover pieces 40 and 42 may include any of the optional or preferred features of the frame 16b.

The motor 30b may be any device that can provide suitable power or activation characteristics. In addition, the gear mechanism 32b can be any device that can provide the desired actuation of the rollers 14b. For example, the motor 30b may be a General Electric washing machine motor having the serial number 5KH42DT748. Another example of the motor 30b is a motor from a single-phase electrical grinder. Additionally, an example of the gear mechanism 32b is a gear mechanism number 581D741 from a Kenmore washing machine. The inventor has discovered that the gear mechanism of a washing machine can be adapted to provide the back and forth rotating motion described above.

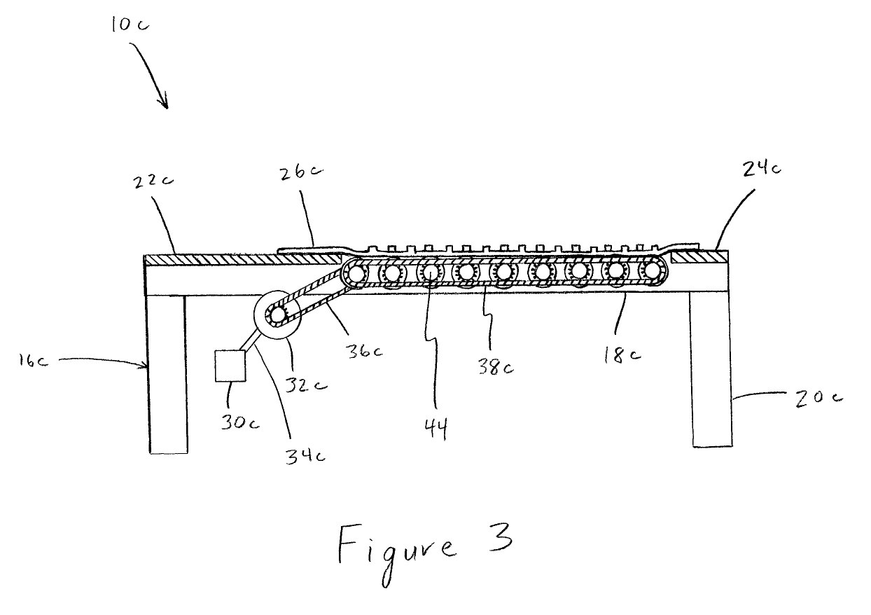

FIG. 3 shows another embodiment 10c of the present invention. It should be recognized that the massage device 10c may include any of the optional or preferred features of the previously described embodiments. In this example, a pegged, plastic or rubber mat 26c is positioned over the rollers of the massage device 10c. In addition, this cross sectional view shows the sprockets 44 on the ends of the rollers. The sprockets 44 may have any appropriate size. An example of a sprocket 44 is a 40×20 sprocket which is adapted to work with a size 40 chain. The sprockets 44 may be secured to the rollers by any conventional means. For example, the sprockets 44 may be secured to the rollers by an adhesive such as an epoxy, by mechanical fastening means such as screws, nails, bolts, clamps, etc., and/or by any other suitable or conventional means.

The massage device of the present invention may have any desired dimensions for different massage applications and/or for different size people. For instance, the massage device could be designed for a person to sit on it or for a person to rest a particular body part on it. In the embodiment shown above, the massage device is horizontally oriented. However, it should be recognized that the massage device may have any other desired orientation, e.g., vertical. It should also be noted that alternative embodiments of the present invention may not have a headrest or a footrest.

The preferred embodiments herein disclosed are not intended to be exhaustive or to unnecessarily limit the scope of the invention. The preferred embodiments were chosen and described in order to explain the principles of the present invention so that others skilled in the art may practice the invention. Having shown and described preferred embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. A massage device comprising:
a frame; and
at least one roller rotatably attached to said frame, said at least one roller adapted to rotate in a predetermined pattern of clockwise and counterclockwise movements.

2. The massage device of claim 1 wherein:
said frame comprises two support members; and
said at least one roller is rotatably attached between said two support members.

3. The massage device of claim 2 wherein said frame further comprises at least one leg connected to said two support members.

4. The massage device of claim 1 wherein:
said frame comprises a headrest, said headrest adapted to support a person's head while using said massage device.

5. The massage device of claim 1 wherein:
said frame comprises a footrest, said footrest adapted to support a person's feet while using said massage device.

6. The massage device of claim 1 further comprising:
a cover extending over said at least one roller;
whereby a person lies on said cover while using said massage device.

7. The massage device of claim 1 wherein said cover is selected from the group consisting of rugs, blankets, sheets, comforters, mats, pads, cushions, carpets, and foam products.

8. The massage device of claim 1 wherein said at least one roller is connected to said frame by a ball-and-socket joint.

9. The massage device of claim 1 wherein said frame is made from a material selected from the group consisting of wood, plastic, metal, and rubber.

10. The massage device of claim 1 wherein said at least one roller is made from a material selected from the group consisting of wood, plastic, metal, and rubber.

11. The massage device of claim 1 wherein said at least one roller has a cross-sectional shape selected from the group consisting of circular shapes, polygonal shapes, and irregular shapes.

12. The massage device of claim 1 wherein said massage device is horizontally oriented.

13. A massage device comprising:
a plurality of rollers adapted to rotate simultaneously and synchronously in a predetermined pattern of clockwise and counterclockwise movements.

14. A massage device comprising:
a frame;
a plurality of rollers rotatably attached to said frame;
a gear mechanism rotatably connected to said rollers;
a motor in communication with said gear mechanism, said motor adapted to drive said gear mechanism such that said rollers rotate in a predetermined pattern of clockwise and counterclockwise movements.

15. The massage device of claim 14 further comprising:
a plurality of sprockets wherein each of said sprockets is connected to a respective one of said rollers; and
a chain engaged with said sprockets thereby rotatably connecting said rollers.

16. The massage device of 14 wherein said gear mechanism is rotatably connected to said motor by a belt.

17. The massage device of claim 14 further comprising:
a sprocket connected to one of said rollers; and
a chain engaged with said sprocket and said gear mechanism, said chain thereby rotatably connecting said gear mechanism to said one of said rollers.

18. The massage device of claim 14 further comprising:
a first chain rotatably connecting said gear mechanism to one of said rollers; and
a second chain rotatably connecting each of said rollers;
whereby said first chain is adapted to actuate said one of said rollers in response to said gear mechanism which in turn causes said second chain to actuate the other ones of said rollers.

19. The massage device of claim 18 further comprising a belt rotatably connecting said motor to said gear mechanism.

20. The massage device of claim 14 wherein said rollers are adapted to rotate simultaneously and synchronously in said predetermined pattern of clockwise and counterclockwise movements.
